(19) United States
(12) Patent Application Publication
(10) Pub. No.: US 2005/0147238 A1
(43) Pub. Date: Jul. 7, 2005

(54) Millennium telephone with integrated directory

(76) Inventor: Larry W. Smith, Atlanta, GA (US)

Correspondence Address: BIDDLE & ASSOCIATES, 6300 POWERS FERRY ROAD, SUITE 600-183, ATLANTA, GA, 30339, US

(21) Appl. No.: 10/749,517

(22) Filed: Jan. 2, 2004

(51) Int. Cl. H04M 1/00

(52) U.S. Cl. 379/453

(57) ABSTRACT

A payphone is provided with an embedded screen or pop-up screen, to display directory listings and advertisements accordingly to area codes, and to adjust with different languages and regions.

1.1. 21st Millennium Phones:

This payphone is to provide an embedded screen or pop-up screen, to display directory listings and advertisements accordingly to area codes, and to adjust with different languages and regions.

1.2. Category:

Telephones-commercially, residential, mobile, and others. It is a new composition of matter. Process, and product to be used for an improvement to an existing technology; a new durable phone case to house these integrated circuits, that will produce the desired listings. The most durable material for commercial use. Residential and mobile phones, the integrated circuit will be housed in regular phone materials.

1.3 General Description:

(a) a payphone that has the capability to give directory Listings, without Lifting the receiver; via computer processing unit to control an integrated control circuit in a semiconductor chip for controlling an apparatus operation of text, i.e. Directory listings on the screen. Interpreting the spoken language through a second computer processing unit in the semiconductor all integrated to give the option of a spoken language. It could also be possible to have an option for internet capabilities; but separate from directory listings through the touch-pad, that has to display data at a high speed delivery rate computer chip. A digitize phonebook, complete with advertisements. Also, it has to have the ability to accept credit cards and voice prompted for directory listings. Voice prompted for dialing numbers and other commandments; all at a high speed delivery rate. Vision impaired humans, will have access to this technology.
(b) it is to eliminate payphone booths with no phone-books, torn, and missing pages; also, there will be no need to dial for a directory assistance, i.e. Commercial, residential, mobile, and/or others.
(c) want the listings to be shown, at a touch of a button and/or an integrated Circuit touch-pad that will give options, if the receiver is not to be lifted. If The receiver is to be lifted, one touch of the touch-pad for directory Listings. The cost of printing books with listings and advertisements will be Displayed more widely, cost efficient, faster, and without any human Assistance. Text on a screen. Voice-prompted capabilities will give an option to the touch-pad; i.e. Assistance for the vision-impaired.
   1.4 Keywords:

Telephone, phone. Pay-phone. Digital-phone. Video-phone. Display-phone, screen-phone, directory listing phones, and voice-promoted.

1.5 Utility and Method of Use:

(a) the 21 st millennium phone is a telephone capable of displaying directory Listings, complete with advertising of business logos and other information. Paper back phonebooks will become obsolete.
(b) possible other uses should be internet capabilities.
(c) a computer processing units, semi-processing units, apparatuses.
   1.6 Novelty and Non-Obviousness:
(a) this invention will eliminate the need for paperback phonebooks, without the need to dial numbers.
(b) others has tried dialing 411 directory assistance, “loop access networking” and nature language processing, through the internet. This phone will Be redesign with some of the same hard material, for commercial use, but The interface will be computerized for any lay person to touch a touch-Pad and/or screen to locate a desired listing. This technology should be Very convenient less and less problematic, than torn pages, missing Phonebooks, and dialing information assistance.
(c) my research has revealed that no others has feature directory listings Digitized integrated circuits. Internal memory formed in the Semiconductor chip for controlling the operation of a custom program Store in the external memory, that creates data.
(d) “network server platform telephone directory white-yellow page services”. U.S. Pat. No. 6,052,439, dated: Apr. 18, 2000.
(e) listings are always to be dialing a number. This 21st century millennium phone is really “let your fingers do the walking”, to your desired listings, with a clear touch of a screen for a desired listing.
   1.7 Method of Synthesis, Assembly , or Process:
(a) this 21st century millennium phone commercially could use the most Durable bullet-proof material available: but this millennium phone is to Be inserted in a protective case, with access to the touch pad screen for Access to all available options. A single button to access local, regional And! Or national directory listings. The computer process unit to lead to Multiple languages, for multiple countries.
(b) a regular commercial phone company's materials could also be used.
(c) a computer processing unit-semi-conductor-read only memory, ram, and all integrated together to control the various options.
   1.8 Limitations:
(a) no disadvantages and no limitations.
(b) further development is contemplated.
   1.9 Experimental Verification:
No.
   1.10 Prototype or Samples:
No.
   1.11 Supporting Materials:

Listed above.

2. Publications and Other Disclosures 01? the Invention:

2.1 Prior Publications:

(a) no.
(b) no.
(b) yes. Within the next six months.
   3. Inventorship:
   3.1 there never was any specify discussion of this invention with anyone. There Was one person that possibly had a quick glance of ruff draft.
   3.2 There is None.
   2.2 Planned Publications:
(a) yes. Whenever mckenna, long, & aldridge and company advise me to do so.
(b) ok.
   2.3 Public Use or Prior Sale:
   (a) no.

1. A telephone with an integrated directory system complete with advertising f business logos and other information, paper back phonebooks is to become obsolete for future phones, whether they are payphones, residential, mobile, cellular, computers, or any other telephone.

2. Central processing unit relays to semi-conductors and RAMS to process the data to be shown on a screen.
